(19) United States
(12) Patent Application Publication
(10) Pub. No.: US 2025/0368913 A1
(43) Pub. Date: Dec. 4, 2025

(54) MULTI-FUNCTIONAL FLUIDS FOR IMPROVING PERFORMANCE OF ELECTRIC DRIVE UNITS

(71) Applicant: EXXONMOBIL TECHNOLOGY AND ENGINEERING COMPANY, Spring, TX (US)

(72) Inventors: Lauren GATHERS, Houston, TX (US); Gordon H. LEE, Southampton, PA (US); Babak LOTFI, New Hope, PA (US); Assylbek IGISSENOV, Praha (CZ)

(73) Assignee: EXXONMOBIL TECHNOLOGY AND ENGINEERING COMPANY, Spring, TX (US)

(21) Appl. No.: 19/217,587

(22) Filed: May 23, 2025

Related U.S. Application Data
(60) Provisional application No. 63/653,594, filed on May 30, 2024.

(51) Int. Cl. C10M 107/10; C10M 145/14; C10N 20/00; C10N 20/02; C10N 30/02; C10N 30/06; C10N 30/18; C10N 40/14

(52) U.S. Cl. CPC C10M 107/10; C10M 145/14; C10M 2205/0285; C10M 2209/084; C10N 2020/02; C10N 2020/067; C10N 2030/02; C10N 2030/06; C10N 2030/18; C10N 2040/14

(57) ABSTRACT

Fluids containing polyalpha-olefins (PAOs) may afford a number of benefits and be multi-functional in nature. Methods for using such multi-functional fluids may comprise: providing a multi-functional fluid comprising about 3 wt % to about 99 wt % of a polyalpha-olefin (PAO), based on a total weight of the multi-functional fluid; and contacting the multi-functional fluid with at least a portion of an electric drive unit. The PAO comprises about 10 mol % or less olefinic bonds and has a kinematic viscosity at 100° C. (KV100), determined pursuant to ASTM D445, of about 3.0 to about 4.5 cSt, and a Noack volatility (NV), determined pursuant to ASTM D5800, of about 15% or less.

### CROSS REFERENCE TO PRIOR APPLICATION

The application claims priority to U.S. Provisional Application 63/653,594 filed May 30, 2024 and titled “MULTI-FUNCTIONAL FLUIDS FOR IMPROVING PERFORMANCE OF ELECTRIC DRIVE UNITS”, the entirety of which is incorporated herein by reference.

### FIELD

The present disclosure generally relates to multi-functional fluids having improved properties, and more particularly, to multi-functional fluids that may convey improved performance of electric drive units, such as in electric vehicles.

### BACKGROUND

Electric vehicles are becoming increasingly more popular with consumers. Although there are some commonalities between electric vehicles and gasoline-powered vehicles, there are significant differences still in need of further technological development. For example, the fluids conventionally used for lubrication of internal combustion engines may not perform as well in electric vehicles. In some cases, conventional fluids may even be incompatible with the electric drive unit or other components of electric vehicles.

Electric vehicles and their electric motors generally operate at much higher speeds and torque than do internal combustion engine vehicles. In the case of a fluid used for lubrication of the electric motor, these differences may lead to increased wear of components and foaming/air entrainment within the fluid. Excessive air entrainment and/or insufficient wear protection may lead to decreased energy efficiency of an electric motor and/or hardware failure. For example, air entrainment may decrease lubricity and fluid pressure, and promote increased oxidative and thermal degradation. Decreased lubricity and fluid pressure may lead to increased system wear, especially at slow operating speeds. Poor heat dissipation can also decrease the operating efficiency of electric motors.

In view of the foregoing, there remains a need for fluids having improved performance for use in conjunction with electric drive units.

### SUMMARY

In various aspects, methods of the present disclosure comprise: providing a multi-functional fluid comprising about 3 wt % to about 99 wt % of a polyalpha-olefin (PAO), based on a total weight of the multi-functional fluid; wherein the PAO comprises about 10 mol % or less olefinic bonds and has a kinematic viscosity at 100° C. (KV100), determined pursuant to ASTM D445, of about 3.0 to about 4.5 cSt, and a Noack volatility (NV), determined pursuant to ASTM D5800, of about 15% or less; and contacting the multi-functional fluid with at least a portion of an electric drive unit.

In various aspects, systems of the present disclosure comprise: a multi-functional fluid comprising about 3 wt % to about 99 wt % of a polyalpha-olefin (PAO), based on total weight of the multi-functional fluid; wherein the PAO comprises about 10 mol % or less olefinic bonds and has a kinematic viscosity at 100° C. (Kv100), determined pursuant to ASTM D445, of about 3.0 to about 4.5 cSt, and a Noack volatility (NV), determined pursuant to ASTM D5800, of about 15% or less; and an electric drive unit having at least a portion thereof in contact with the multi-functional fluid.

These and other features and attributes of the disclosed methods and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram of an illustrative electric drive unit.

FIG. 2 is a graph showing release times to reach 0.2 vol % entrained air in various multi-functional fluids, as measured according to ISO 9120.

FIG. 3 is a graph showing air entrainment of various multi-functional fluids, based on volume increase at 120° C., as measured according to ZF 0000 702 461.

FIG. 4 is a graph showing air release of various multi-functional fluids, based on pressure loss at 120° C., as measured according to ZF 0000 702 461.

FIG. 5 is a graph of torque and power as a function of operating rate used in the foaming test phase of the examples.

FIG. 6 is a graph of torque and power as a function of operating rate used in the oil-aging test phase of the examples.

FIG. 7 is a bar graph showing the results of the first foaming testing phase for the experimental and comparative fluids at each of the testing matrix points of the examples.

FIG. 8 is a bar graph showing the results of the second foaming testing phase for the experimental and comparative fluids at each of the testing matrix points of the examples.

FIG. 9 is a bar graph showing the results of slow speed gear wear testing for the experimental and comparative fluids of the examples.

### DETAILED DESCRIPTION

The present disclosure generally relates to multi-functional fluids having improved properties, and more particularly, to multi-functional fluids that may convey improved performance of electric drive units, such as in electric vehicles.

In response to the foregoing issues, the present disclosure provides multi-functional fluids containing polyalpha-olefins (PAOs) suitable for use in electric vehicles. Advantageously, the multi-functional fluids described herein may afford low air entrainment and low system wear, especially at slow operating speeds (slow speed gear wear). In turn, the improved air entrainment and low system wear may result in improved operating efficiency and lifetime of the electric drive unit or a portion thereof, as well as a longer fluid lifetime due to decreased oxidative and thermal degradation. Further, the multi-functional fluids of the present disclosure may exhibit better performance in back-to-back testing in comparison to other fluids, as well as improved thermal properties.

Multi-functional fluids of the present disclosure may comprise: about 3 wt % to about 99 wt % of at least one polyalpha-olefin (PAO), based on a total weight of the multi-functional fluid; wherein the at least one PAO comprises about 10 mol % olefinic bonds or less and has a kinematic viscosity at 100° C. (KV100), determined pursuant to ASTM D445, of about 3.0 to about 4.5 cSt and a Noack volatility (NV), determined pursuant to ASTM D5800, of about 15% or less. In accordance with the present disclosure, the multi-functional fluids may be contacted with an electric drive unit, such as within an electric vehicle, in order to promote operation thereof.

The term “polyalpha-olefin(s)” (PAO(s)) includes any oligomer(s) and/or polymer(s) of one or more alpha-olefin monomer(s). Alpha-olefins have a terminal double bond on their carbon chain. PAOs may be produced from the polymerization reaction of alpha-olefin monomer molecules in the presence of a catalyst and optionally further hydrogenated to remove residual carbon-carbon double bonds (olefinic bonds) therefrom. PAOs may be dimers, trimers, tetramers, or even higher oligomers derived from one or more alpha-olefin monomers. The PAOs may be highly regio-regular such that the bulk material exhibits isotacticity or syndiotacticity when assayed by ¹³C NMR. Preferably, at least a majority of the PAOs in the multi-functional fluids is a trimer. The PAOs may be highly regio-irregular such that the bulk material is substantially atactic when assayed by ¹³C NMR. In non-limiting examples, PAOs may be made using metallocene-based catalysts or traditional non-metallocene based catalysts (e.g., Lewis acids, supported chromium oxide, or the like).

The multi-functional fluids may comprise about 3 wt % to about 99 wt % PAOs, or about 3 wt % to about 98 wt % PAOs, or about 50 wt % to about 98 wt % PAOs, based on the total weight of the multi-functional fluid.

The PAOs may comprise olefinic bonds in an amount of about 10 mol % or less, or about 5 mol % or less, or about 3 mol % or less, or about 1 mol % or less, based on a total molar amount of the PAOs. Thus, the PAOs may be partially unsaturated or fully saturated PAOs. Preferably, the PAOs are substantially fully saturated. Any double bonds that do remain in the PAOs may include one or more of vinyl, disubstituted vinylene, trisubstituted vinylene, or vinylidene. The extent of unsaturation and amount of these types of double bonds may be determined by NMR spectroscopy, for example. The PAOs may contain a plurality of alkyl groups extending as side chains from the main backbone of the PAOs. The alkyl groups and the length thereof may be determined by the alpha olefins that undergo oligomerization to form the PAOs. In non-limiting examples, the alkyl groups may be, for instance, n-butyl, n-hexyl, n-octyl, n-decyl, n-dodecyl, or any combination thereof.

In non-limiting examples, the one or more PAOs may comprise C28-C32 PAOs at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Preferably, the C28-C32 PAOs may comprise a trimer of one or more C4-C12 linear alpha olefins (LAOs).

In one or more embodiments, the one or more PAOs may comprise C30 PAOs at a total concentration of about 90 wt % or greater, or about 92 wt % or greater, or about 94 wt % or greater, or about 95 wt % or greater, or about 96 wt % or greater, or about 97 wt % or greater, or about 98 wt % or greater, based on total weight of the one or more PAOs. Fully saturated C30 PAOs may be represented by the formula C₃₀H₆₂, which may be a single alkane isomer or a mixture of multiple (e.g., two, three, four, or more) alkane isomers.

The multi-functional fluids of the present disclosure may include one or more viscosity modifiers. Suitable viscosity modifiers may contribute to higher viscosities at high temperatures and offer minimal viscosity contribution at lower temperatures. Illustrative viscosity modifiers may include, but are not limited to, polyalkyl methacrylates, olefin copolymers (OCPs) such as ethylene-propylene copolymers (e.g., EPM/EPDMs, and the like), polyisobutylenes (PIBs), hydrogenated styrene-dienes (HSDs), the like, and mixtures thereof.

The multi-functional fluids of the present disclosure may also include one or more thickeners. Suitable thickeners may be present in the multi-functional fluids in an amount of about 1 wt % to about 14 wt %, or about 1 wt % to about 12 wt %, or about 1 wt % to about 5 wt %, or about 1 wt % to about 3 wt %, or about 1.5 wt % to about 2.5 wt %, based on total weight of the multi-functional fluid. Illustrative examples of suitable thickeners will be familiar to persons having ordinary skill in the art.

The multi-functional fluids of the present disclosure may include anti-foaming agents such as, for example, silicones, polydimethyl siloxanes, acrylate ether copolymers, acrylate copolymers such as 2-ethylhexyl acrylate/vinyl acetate copolymer, fluorosilicone oils, the like, and any combination thereof. The anti-foaming agents may be present in the multi-functional fluids in an amount of about 0.001 wt % to about 0.2 wt %, or about 0.001 wt % to about 0.1 wt. %, or about 0.01 wt % to about 0.1 wt %, or about 0.05 wt % to about 0.15 wt %, based on total weight of the multi-functional fluid.

The multi-functional fluids of the present disclosure may additionally contain one or more additional components including but not limited to dispersants, detergents, anti-wear additives, corrosion inhibitors, rust inhibitors, metal deactivators, extreme pressure additives, anti-seizure agents, wax modifiers, fluid-loss additives, seal compatibility agents, lubricity agents, anti-staining agents, chromophoric agents, de-emulsifiers, densifiers, wetting agents, gelling agents, tackiness agents, colorants, and others. Suitable examples of the foregoing and amounts commonly used will be familiar to persons having ordinary skill in the art. When multi-functional fluids contain one or more of the components discussed above, the component(s) are blended into the multi-functional fluid in an amount sufficient for the component(s) to perform its intended function.

It is noted that many of the foregoing additives are shipped from an additive manufacturer as a concentrate, sometimes containing one or more additives together, within a base oil diluent. For example, the base oil diluent may comprise about 5 wt % to about 50 wt % of the concentrate before blending to form a multi-functional fluid. The additives useful in this disclosure do not necessarily have to be soluble in the multi-functional fluids and instead may be present as dispersed solids.

The one or more PAOs may have a KV100 of about v1 to about v2 cSt, where v1 and v2 may be, independently, 3.0, 3.1, 3.2, 3.3, 3.4, 3.5, 3.6, 3.7, 3.8, 3.9, 4.0, 4.1, 4.2, 4.3, 4.4, and 4.5, where v1 and v2 are determined according to ASTM D445 and v1<v2. In non-limiting examples, v1 is 3.0 and v2 is 4.0; or v1 is 3.0 and v2 is 3.6; or v1 is 3.0 and v2 is 3.5.

The one or more PAOs may have a NV of about 15.0 wt % or less, or about 14.0 wt % or less, or about 13.0 wt % or less, or about 12.5 wt % or less, each determined pursuant to ASTM D5800.

The one or more PAOs may have a thermal conductivity at 40° C. of about 0.11 W·(m·C)⁻¹ to about 0.16 W·(m·° C.)⁻¹. All thermal conductivity values in this disclosure are determined according to ASTM D7896-19 and are reported in W·(m·° C.)⁻¹, unless otherwise specified.

The one or more PAOs may have a cold-cranking-simulator viscosity (CCSV) at −35° C. of about a1 to about a2 centipoise (cP), where a1 and a2 may be, independently, 500, 550, 600, 650, 700, 750, 800, 850, 900, or 1000, provided that al is less than a2. All CCSV values in this disclosure are determined according to ASTM D5293 and are reported in cP (milliPascal·second), unless otherwise specified.

The one or more PAOs may have a high-temperature, high-shear viscosity (HTHSV) at 150° C. of about 1.4 cP or less, such as about 1.0 cP to about 1.4 cP, or about 1.0 cP to about 1.3 cP, or about 1.0 cP to about 1.2 cP. All HTHSV values in this disclosure are determined according to ASTM D4683 and are reported in cP, unless otherwise specified.

The one or more PAOs may have a high oxidation stability indicated by rotating pressure vessel oxidation test (RPVOT) break time of at least about 60 minutes, or at least about 70 minutes, or at least about 80 minutes. All RPVOT values in this disclosure are as determined according to ASTM D2272 and are reported in minutes, unless otherwise specified.

The multi-functional fluids may have an air release value at 40° C. in a range of about e1 to about e2, where e1 and e2 may be, independently, 100, 120, 140, 160, 180, 200, 220, 240, 260, 280, and 300. Preferably, e1=120 and e2=200. More preferably e1=130 and e2=150. The multi-functional fluids may have an air release value at 50° C. in a range of about f1 to about f2, where f1 and f2 may be, independently, 50, 55, 60, 65, 70, 75, 80, 85, 90, 95, 100, 110, 120, 130, 140, 150, 160, 170, 180, 190, and 200. Preferably, f1=50 and f2=75. More preferably, f1=60 and f2=70. All air release values in this disclosure are determined according to ISO 9120, unless otherwise specified. The unit of all air release values herein is seconds(s), unless otherwise specified.

The multi-functional fluids may have a slow speed gear wear value in a range from about g1 to about g2, where g1 and g2 may be, independently, 500, 525, 550, 575, 600, 625, 675, 700, 725, 750, 775, 800, 825, 850, 875, 900, 1,000, 1,100, 1,200, 1,300, 1,400, 1,500, 1,600, 1,700, 1,800, 1,900, 2,000, and 2,100. Preferably, g1=600 and g2=750. More preferably, g1=650 and g2=700. More preferably, g1=660 and g2=680. The foregoing values may be up to about 70% of the wear exhibited by a test substrate in the presence of a reference fluid. The multi-functional fluids may have a slow speed gear wear value at 50% fail in a range of about h1 to about h2, where h1 and h2 may be, independently, 30, 35, 40, 45, 50, 55, 60, 65, 70, 75, 80, 85, 90, 95, 100, 110, 120, 130, 140, 150, 160, 170, 180, 190, 200, and 210. Preferably, h1=45 and h2=65. More preferably, h1=50 and h2=60. All slow speed gear wear values are as determined according to DGMK 377, unless otherwise specified. The unit of all slow speed gear wear values herein is mg, unless otherwise specified. The DGMK 377 Slow Speed Gear Wear Test, C/0.05/90:120/12, is a three-part test that determines the wear characteristics of lubricants at two different temperatures under mixed and boundary conditions. An additional test procedure, C/0.57/90/12, investigates the effect of speed. The DGMK 377 test is run on a modified FZG gear test rig with pinion driving, using C-PT gear types, the same as the gears used for the FZG Pitting Test, with dip lubrication. After each time period and at fixed temperature, speed and load, the weight loss of the pinion and wheel are recorded. Part 1 is run at 90° C. at a speed of 0.05 m/s. Part 2 shows the effect of a higher operating temperature of 120° C. Part 3 shows the effect of a higher speed of 0.57 m/s.

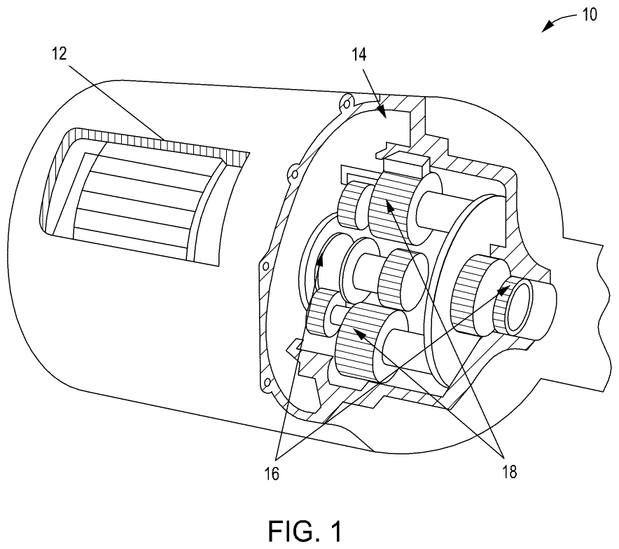

FIG. 1 is a diagram of an electric drive unit in which the multi-functional fluids may be used. Although FIG. 1 has shown a particular electric drive unit 10, the configuration and components of electric drive unit 10 are not particularly limited when used in conjunction with the multi-functional fluids described herein. Electric drive unit 10 may include electric motor 12, gearbox 14, one or more bearings 16, one or more gears 18, and optionally an axle (not shown). The type of electric motor 12 is not particularly limited and may include one or more permanent magnets. The multi-functional fluids may circulate through electric motor 12 or be sprayed onto electric motor 12 or a component thereof to promote lubrication and potentially to provide other advantageous benefits. In non-limiting examples, the multi-functional fluids may be contacted with gearbox 14 to reduce friction between one or more gears 18 or another portion of electric drive unit 10.

### ADDITIONAL EMBODIMENTS

The present disclosure is further directed to the following non-limiting embodiments: Embodiment 1. A method comprising:
providing a multi-functional fluid comprising about 3 wt % to about 99 wt % of a polyalpha-olefin (PAO), based on a total weight of the multi-functional fluid;
   wherein the PAO comprises about 10 mol % or less olefinic bonds and has a kinematic viscosity at 100° C. (KV100), determined pursuant to ASTM D445, of about 3.0 to about 4.5 cSt, and a Noack volatility (NV), determined pursuant to ASTM D5800, of about 15% or less; and
contacting the multi-functional fluid with at least a portion of an electric drive unit.

Embodiment 2. The method of Embodiment 1, wherein the PAO comprises C28-C32 polyalpha-olefins at a concentration of about 95 wt % or greater, based on total weight of the PAO.

Embodiment 3. The method of Embodiment 2, wherein the PAO comprises C30 polyalpha-olefins at a concentration of about 95 wt % or greater, based on total weight of the PAO.

Embodiment 4. The method of any one of Embodiments 1-3, wherein the PAO has a thermal conductivity at 40° C. of about 0.11 W·(m·C)⁻¹ to 0.16 W·(m·C)⁻¹, determined pursuant to ASTM D7896-19.

Embodiment 5. The method of any one of Embodiments 1-4, wherein the PAO has a high-temperature high-shear viscosity of about 1.4 cP or less, determined pursuant to ASTM D4683 at 150° C.

Embodiment 6. The method of any one of Embodiments 1-5, wherein the electric drive unit comprises an electric motor, one or more bearings, and a gearbox.

Embodiment 7. The method of Embodiment 6, wherein the electric drive unit further comprises at least one permanent magnet.

Embodiment 8. The method of any one of Embodiments 1-7, wherein the multi-functional fluid further comprises a viscosity modifier.

Embodiment 9. The method of any one of Embodiments 1-8, wherein the multi-functional fluid further comprises an anti-foam agent.

Embodiment 10. The method of any one of Embodiments 1-7, wherein the multi-functional fluid comprises about 2 wt % to about 98 wt % of the PAO, about 2 wt % to about 14 wt % of a polyalkyl methacrylate, and about 0.001 wt % to about 0.2 wt % of an anti-foam agent, each based on total weight of the multi-functional fluid.

Embodiment 11. The method of Embodiment 10, wherein the multi-functional fluid has an air release at 40° C. of about 120 s to about 200 s, as determined by ISO 9120.

Embodiment 12. The method of Embodiment 10 or Embodiment 11, wherein the multi-functional fluid has a slow speed gear wear value of about 600 mg to about 750 mg, as determined by DGMK 377.

Embodiment 13. A system comprising:
a multi-functional fluid comprising about 3 wt % to about 99 wt % of a polyalpha-olefin (PAO), based on total weight of the multi-functional fluid;
   wherein the PAO comprises about 10 mol % or less olefinic bonds and has a kinematic viscosity at 100° C. (Kv100), determined pursuant to ASTM D445, of about 3.0 to about 4.5 cSt, and a Noack volatility (NV), determined pursuant to ASTM D5800, of about 15% or less; and
an electric drive unit having at least a portion thereof in contact with the multi-functional fluid.

Embodiment 14. The system of Embodiment 13, wherein the electric drive unit comprises an electric motor, one or more bearings, and a gearbox.

Embodiment 15. The system of Embodiment 14, wherein the electric drive unit comprises at least one permanent magnet.

Embodiment 16. The system of any one of Embodiments 13-15, wherein the PAO comprises C28-C32 polyalpha-olefins at a concentration of about 95 wt % or greater, based on total weight of the PAO.

Embodiment 17. The system of Embodiment 16, wherein the PAO comprises C30 polyalpha-olefins at a concentration of about 95 wt % or greater, based on total weight of the PAO.

Embodiment 18. The system of any one of Embodiments 13-17, wherein the PAO has a thermal conductivity at 40° C. of about 0.11 W·(m·K)⁻¹ to about 0.16 W·(m·K)⁻¹, determined pursuant to ASTM D7896-19.

Embodiment 19. The system of any one of Embodiments 13-18, wherein the PAO has a high-temperature high-shear viscosity of about 1.4 cP or less, determined pursuant to ASTM D4683 at 150° C.

Embodiment 20. The system of any one of Embodiments 13-19, wherein multi-functional fluid comprises about 3 wt % to about 90 wt % of the PAO, about 2 wt % to about 14 wt % of a polyalkyl methacrylate, and about 0.001 wt % to about 0.2 wt % of an anti-foam agent, each based on total weight of the multi-functional fluid.

Embodiment 21. The system of Embodiment 20, wherein the multi-functional fluid has an air release at 40° C. of about 120 s to about 200 s, as determined by ISO 9120.

Embodiment 22. The system of Embodiment 20 or Embodiment 21, wherein the multi-functional fluid has a slow speed gear wear value of about 600 mg to about 750 mg as determined by DGMK 377.

To facilitate a better understanding of the embodiments of the present disclosure, the following examples of preferred or representative embodiments are given. In no way should the following examples be read to limit, or to define, the scope of the invention.

### EXAMPLES

The properties of example multi-functional fluids were evaluated, the compositions for which are specified in Table 1 below. The multi-functional fluids consisted of various base oils and a fixed amount of further additives or other components. Experimental Fluid 1 was formulated with SPECTRASYN MAX 3.5 (ExxonMobil), which is a blend of PAOs corresponding to those described herein. Comparative Fluid 1 was formulated with a blend of Group II+ and Group III+ base oils. Comparative Fluid 2 was formulated with a blend of Group II+ and Group III base oils. Comparative Fluid 3 was formulated with a blend of Group IV base oils (Group IV BO-1 and Group IV BO-2). Comparative Fluid 4 was formulated with a blend of a Group II base oil and a Group IV base oil (Group IV BO-2).

TABLE 1

| | Exp. | Comp. | Comp. | Comp. | Comp. |
|---|---|---|---|---|---|
| | Fluid 1 | Fluid 1 | Fluid 2 | Fluid 3 | Fluid 4 |
| Component | (amount in parts per hundred) | | | | |
| Group II BO/ | | | | | 59.3/30.4 |
| Group IV BO-1 | | | | | |
| Group II + BO/ | | | 54.7/35.0 | | |
| Group III BO | | | | | |
| Group I I+ BO/ | | 34.7/55.0 | | | |
| Group III + BO | | | | | |
| Group IV BO-1/ | | | | 15.3/74.4 | |
| Group IV BO-2 | | | | | |
| SPECTRASYN | 89.7 | | | | |
| MAX 3.5 | | | | | |
| Viscosity | 2.2 | 2.2 | 2.2 | 2.2 | 2.2 |
| modifier | | | | | |
| Additive | 8.0 | 8.0 | 8.0 | 8.0 | 8.0 |
| package | | | | | |
| for EV fluids | | | | | |
| Anti-foam | 0.1 | 0.1 | 0.1 | 0.1 | 0.1 |
| agent | | | | | |

Selected properties of the multi-functional fluids are specified in Table 2 below.

TABLE 2

| Viscometric | Exp. | Comp. | Comp. | Comp. | Comp. |
|---|---|---|---|---|---|
| Property | Fluid 1 | Fluid 1 | Fluid 2 | Fluid 3 | Fluid 4 |
| KV100, | 4.45 | 4.39 | 4.38 | 4.40 | 4.43 |
| ASTM | | | | | |
| D445 (cSt) | | | | | |
| KV40, | 18.9 | 18.8 | 19.1 | 18.8 | 19.6 |
| ASTM | | | | | |
| D445 (cSt) | | | | | |
| Viscosity | 154 | 149 | 143 | 150 | 141 |
| Index | | | | | |
| (unitless) | | | | | |

The multi-functional fluids were further evaluated with respect to their properties while operating a test electric motor. The test electric motor was a permanent magnet synchronous motor, further characteristics of which are specified in Table 3 below.

TABLE 3
Electric drive-unit (1 speed)

| | |
|---|---|
| Peak Power | 250 kW |
| Continuous Power | 80 kW |
| Max Torque | 400 N · m |
| Max Speed | 17,000 rpm |

### Foam and Aeration Testing.

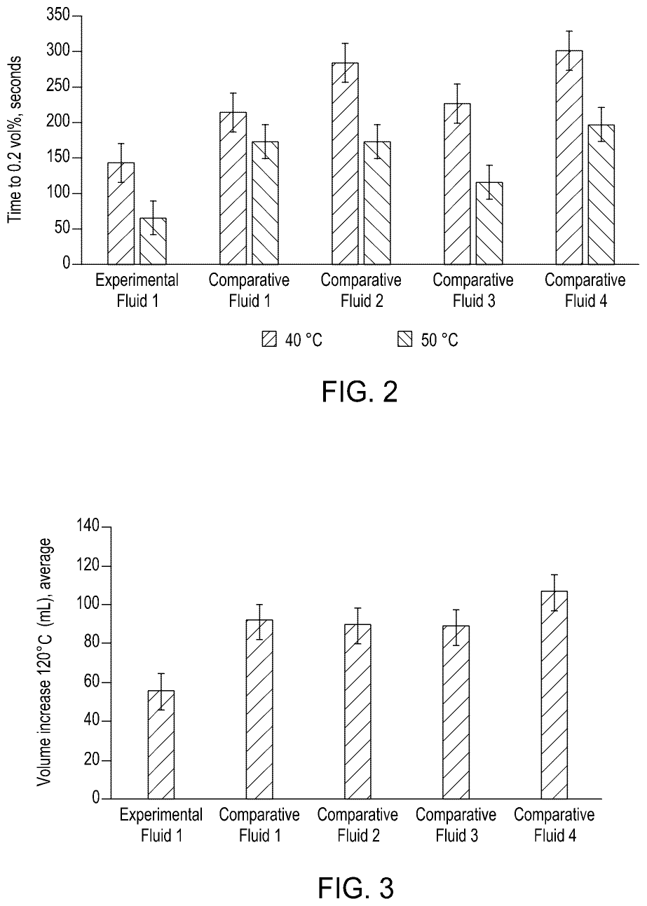

Foam and aeration testing performance of the multi-functional fluids was determined according to ISO 9120 and ZF 0000 702 461 procedures. The ISO 9120 test procedure determines the ability of a multi-functional fluid to separate from entrained air, as measured by the time for the entrained air content to fall to 0.2 vol % under standardized test conditions. Testing was conducted by blowing air into the multi-functional fluids under pressure at 40° C. and 50° C., followed by measurement of density as a function of time to determine the dispersed air content. The time for the air content to decrease to 0.2 vol % was recorded. FIG. 2 is a graph showing release times to reach 0.2 vol % entrained air, as measured according to ISO 9120. As shown, Experimental Fluid 1 achieved significantly faster air release than did any of the comparative multi-functional fluids at either test temperature.

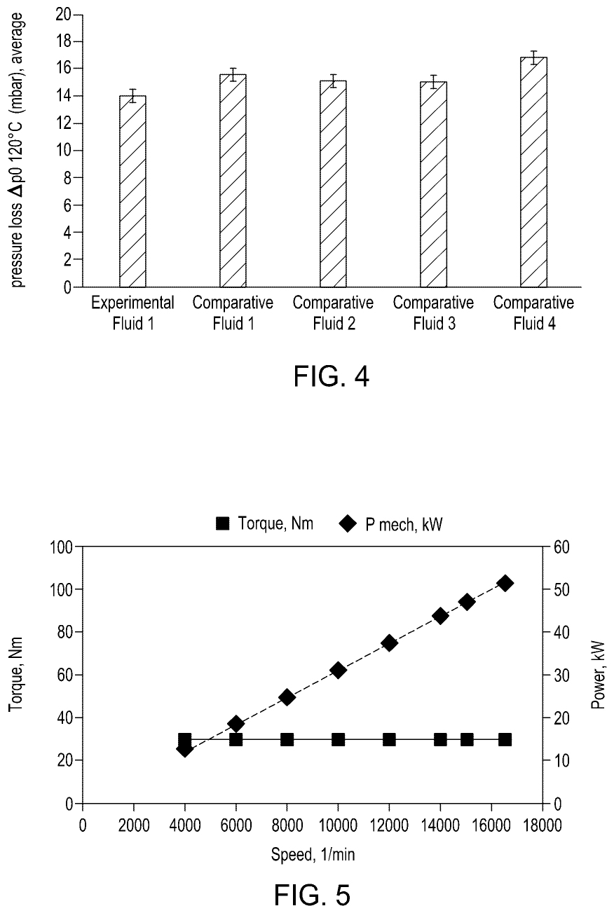

The multi-functional fluids were also tested to determine their air entrainment, air release, and foaming performance at 90° C. and 120° C., as measured according to ZF 0000 702 461. The test includes recirculation of 500 mL of sample at a constant volumetric flow with a defined air supply (350 mL/min) for 7 minutes, followed by measurement of the differential pressure and foaming tendency assessment before and after shutting off the air supply. The volumetric flow was regulated to achieve a desired differential pressure. Results are shown in FIGS. 3 and 4. FIG. 3 is a graph showing the air entrainment of the multi-functional fluids, based on volume increase at 120° C., as measured according to ZF 0000 702 461. FIG. 4 is a graph showing air release of the multi-functional fluids, based on pressure loss at 120° C., as measured according to ZF 000 0702 461. As shown, the experimental multi-functional fluid achieved significantly less air entrainment and a lower pressure loss than did any of the comparative multi-functional fluids. The corresponding data obtained at 90° C. was similar.

The multi-functional fluids were further tested for gas content during use in an electric motor. The test procedure first consisted of a 1-hour running-in phase, at an operating rate of 500 rpm and at 50 N·m torque. A stabilization phase in which the multi-functional fluids were conditioned to 23° C. followed. Next, the test consisted of an efficiency testing phase (first efficiency testing phase) at 23° C., which included three harmonized Worldwide Light Vehicles Test Cycles (WLTC).

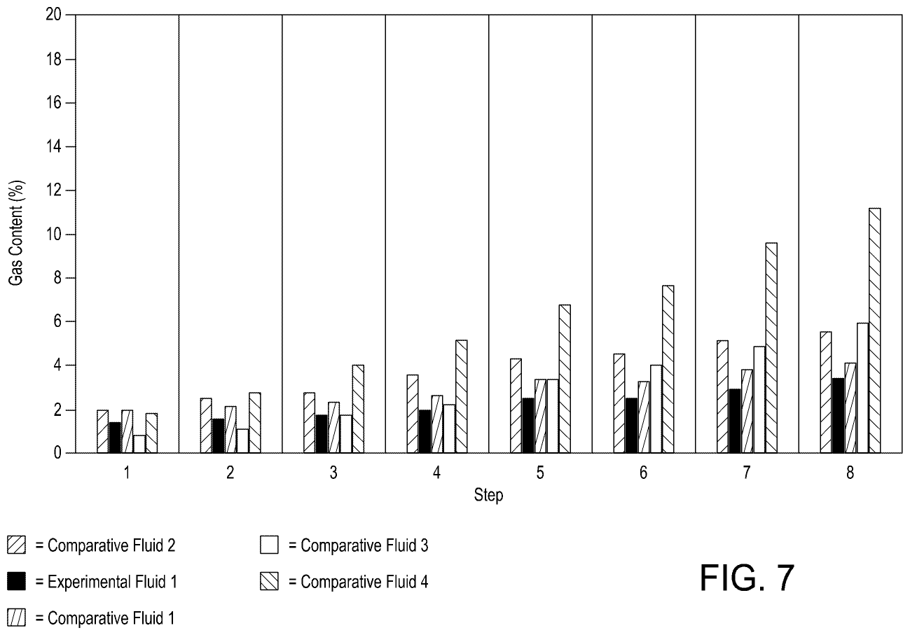

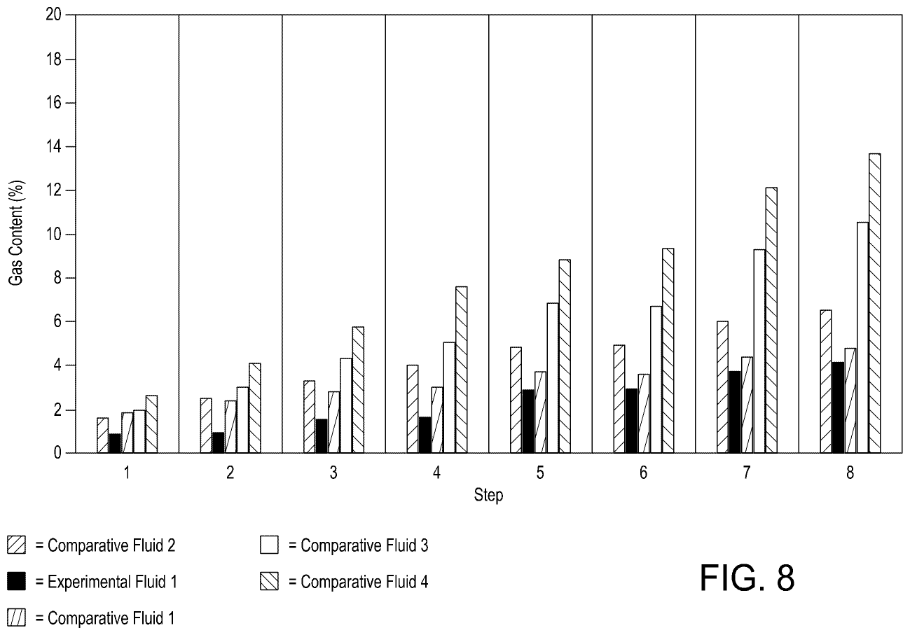

A foaming test phase (first foaming test phase) was then performed, which included (1) a conditioning run during which the motor was run for 30 min at 12,500 rpm without a load, and subsequently (2) an 8-point steady state matrix evaluation at various operating rates (4,000 rpm, 6,000 rpm, 8,000 rpm, 10,000 rpm, 12,000 rpm, 14,000 rpm, 15,000 rpm and 16,500 rpm (steps 1-8 in FIGS. 7 and 8 below), and gas content was measured after stabilization at each rate using an in-line sensor to a precision of +/−1%. FIG. 5 is a graph of torque and power as a function of operating rate used in the foaming test phase. The gas content was measured three times at each set point in the test procedure with a 10-minute load.

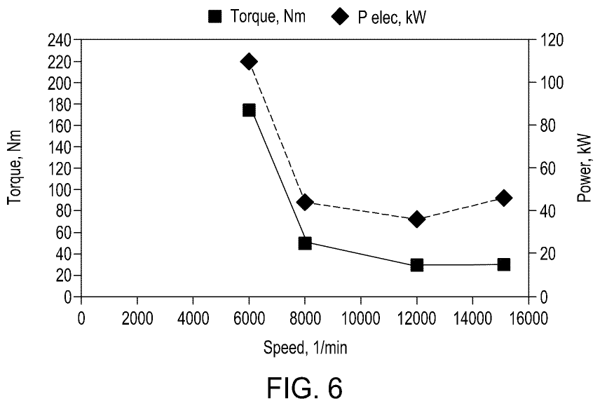

A 60-hour oil-aging phase then followed. This testing stage utilized a 4-point steady state matrix evaluation at various operating rates (6,000 rpm, 8,000 rpm, 12,000 rpm, and 15,000 rpm), each run was conducted for 15 minutes over 60 cycles (60 hours total aging) and gas content was measured after stabilization at each rate. FIG. 6 is a graph of torque and power as a function of operating rate used in the oil-aging test phase. At each set point, each parameter was allowed to stabilize before obtaining a measurement.

Next, the foaming test phase was performed again (second foaming test phase), and another efficiency testing phase (second efficiency test phase) was performed thereafter. Both tests were performed in the same manner previously described.

FIG. 7 is a bar graph showing the results of the first foaming testing phase for the experimental and comparative fluids at each of the testing matrix points. As shown, Experimental Fluid 1 had low gas contents at all of the matrix testing points, and demonstrated the lowest gas content of all fluids at the three highest rpm values.

FIG. 8 is a bar graph showing the results of the second foaming testing phase for the experimental and comparative fluids at each of the testing matrix points. As shown, Experimental Fluid 1 had a lower gas content than did all other fluids at each of the matrix testing points.

As shown, Experimental Fluid 1 containing SPECTRASYN MAX 3.5 had superior foam and aeration properties in comparison to the other multi-functional fluids.

### Slow Speed Gear Wear Testing.

The five multi-functional fluids were also subjected to slow speed gear wear testing. The test procedure was DGMK 377 and involved three phases, as shown in Table 4. The motor used to evaluate the multi-functional fluid had a planetary gearbox design with gear set rpm values at different speeds in operation. Wear was evaluated based on the following metrics, based on the sum of wear per test part: Low (less than 50 mg of wear), Medium (50 mg to 200 mg of wear), High (200 mg to 500 mg of wear), and Very High (greater than 500 mg of wear).

TABLE 4

| | Phase 1 | Phase 2 | Phase 3 |
|---|---|---|---|
| Engine Speed | 8 | 8 | 100 |
| (min⁻¹) | | | |
| Multi-functional | 90 ± 3 | 120 ± 3 | 90 ± 3 |
| fluid Temperature | | | |
| (° C.) | | | |
| Total Test | 11,500 | 11,500 | 288,000 |
| Revolutions | | | |
| Test length (h) | 24 | 24 | 48 |
| Number of tests run | 2 | 2 | 1 |

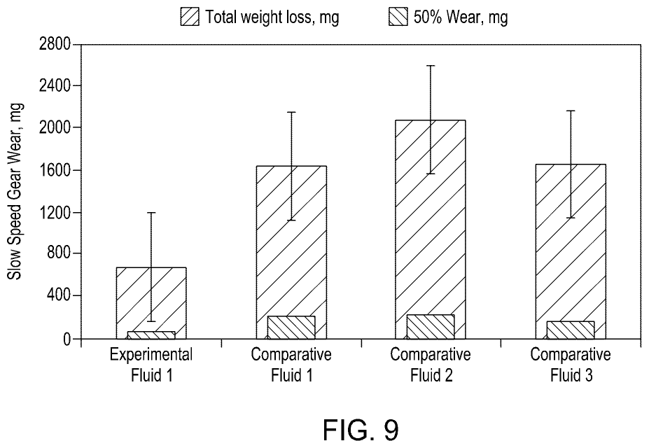

FIG. 9 is a bar graph showing the results of slow speed gear wear testing for the experimental and comparative fluids. As shown, Experimental Fluid 1 had significantly lower slow speed gear wear at 50% probability fail and in total than did the comparative fluids. This result may be indicative of good start-up gear protection and protection for low-RPM motors and high load gear box operations (e.g., e-truck towing or class 5 delivery). Results for Comparative Fluid 4 were discarded due to a testing error.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces and the term “or” means the disjunctive.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method comprising:
providing a multi-functional fluid comprising about 3 wt % to about 99 wt % of a polyalpha-olefin (PAO), based on a total weight of the multi-functional fluid;
wherein the PAO comprises about 10 mol % or less olefinic bonds, and
wherein the PAO has a kinematic viscosity at 100° C. (KV100), determined pursuant to ASTM D445, of about 3.0 to about 4.5 cSt, and
wherein the PAO has a Noack volatility (NV), determined pursuant to ASTM D5800, of about 15% or less; and
contacting the multi-functional fluid with at least a portion of an electric drive unit.

2. The method of claim 1, wherein the PAO comprises C28-C32 polyalpha-olefins at a concentration of about 95 wt % or greater, based on total weight of the PAO.

3. The method of claim 2, wherein the PAO comprises C30 polyalpha-olefins at a concentration of about 95 wt % or greater, based on total weight of the PAO.

4. The method of claim 1, wherein the PAO has a thermal conductivity at 40° C. of about 0.11 W·(m·C)⁻¹ to 0.16 W·(m·C)⁻¹, determined pursuant to ASTM D7896-19.

5. The method of claim 1, wherein the PAO has a high-temperature high-shear viscosity of about 1.4 cP or less, determined pursuant to ASTM D4683 at 150° C.

6. The method of claim 1, wherein the electric drive unit comprises an electric motor, one or more bearings, and a gearbox and wherein the electric drive unit further comprises at least one permanent magnet.

7. The method of claim 1, wherein the multi-functional fluid further comprises a viscosity modifier, an anti-foam agent, or both.

8. The method of claim 1, wherein the multi-functional fluid comprises
about 2 wt % to about 98 wt % of the PAO,
about 2 wt % to about 14 wt % of a polyalkyl methacrylate, and
about 0.001 wt % to about 0.2 wt % of an anti-foam agent, each based on total weight of the multi-functional fluid.

9. The method of claim 8, wherein the multi-functional fluid has an air release at 40° C. of about 120 s to about 200 s, as determined by ISO 9120.

10. The method of claim 8, wherein the multi-functional fluid has a slow speed gear wear value of about 600 mg to about 750 mg, as determined by DGMK 377.

11. A system comprising:
a multi-functional fluid comprising about 3 wt % to about 99 wt % of a polyalpha-olefin (PAO), based on total weight of the multi-functional fluid;
wherein the PAO comprises about 10 mol % or less olefinic bonds and
wherein the PAO has a kinematic viscosity at 100° C. (Kv100), determined pursuant to ASTM D445, of about 3.0 to about 4.5 cSt, and
wherein the PAO has a Noack volatility (NV), determined pursuant to ASTM D5800, of about 15% or less; and
an electric drive unit having at least a portion thereof in contact with the multi-functional fluid.

12. The system of claim 11, wherein the electric drive unit comprises an electric motor, one or more bearings, and a gearbox.

13. The system of claim 12, wherein the electric drive unit comprises at least one permanent magnet.

14. The system of claim 11, wherein the PAO comprises C28-C32 polyalpha-olefins at a concentration of about 95 wt % or greater, based on total weight of the PAO.

15. The system of claim 14, wherein the PAO comprises C30 polyalpha-olefins at a concentration of about 95 wt % or greater, based on total weight of the PAO.

16. The system of claim 11, wherein the PAO has a thermal conductivity at 40° C. of about 0.11 W·(m·K)⁻¹ to about 0.16 W·(m·K)⁻¹, determined pursuant to ASTM D7896-19.

17. The system of claim 11, wherein the PAO has a high-temperature high-shear viscosity of about 1.4 cP or less, determined pursuant to ASTM D4683 at 150° C.

18. The system of claim 11, wherein multi-functional fluid comprises about 3 wt % to about 90 wt % of the PAO, about 2 wt % to about 14 wt % of a polyalkyl methacrylate, and about 0.001 wt % to about 0.2 wt % of an anti-foam agent, each based on total weight of the multi-functional fluid.

19. The system of claim 18, wherein the multi-functional fluid has an air release at 40° C. of about 120 s to about 200 s, as determined by ISO 9120.

20. The system of claim 18, wherein the multi-functional fluid has a slow speed gear wear value of about 600 mg to about 750 mg as determined by DGMK 377.
